(19) United States
(12) Patent Application Publication
(10) Pub. No.: US 2021/0172848 A1
(43) Pub. Date: Jun. 10, 2021

(54) VISCOSITY SENSOR FOR REAL-TIME MONITORING OF TUBULAR CONDUITS AND METHOD

(71) Applicant: KING ABDULLAH UNIVERSITY OF SCIENCE AND TECHNOLOGY, Thuwal (SA)

(72) Inventors: Maha Ahmed NOUR, Thuwal (SA); Muhammad Mustafa HUSSAIN, Hercules, CA (US)

(21) Appl. No.: 17/116,746

(22) Filed: Dec. 9, 2020

Related U.S. Application Data
(60) Provisional application No. 62/946,192, filed on Dec. 10, 2019.

(51) Int. Cl. G01N 11/04

(52) U.S. Cl. CPC G01N 11/04

(57) ABSTRACT

A viscosity sensor for measuring a viscosity of a fluid flowing in a pipe, includes a base made of a flexible material; a bridge made of a rigid material, wherein the bridge is attached to the base to form a microchannel; a pressure sensor formed within the base; and a controller configured to receive a signal indicative of a capacitance change ΔC from the pressure sensor, and to calculate the viscosity of the fluid flowing through the microchannel based on the received capacitance change ΔC.

### CROSS-REFERENCE TO RELATED APPLICATIONS

This application claims priority to U.S. Provisional Patent Application No. 62/946,192, filed on Dec. 10, 2019, entitled “ONLINE MONITORING FLUID'S VISCOSITY IN PIPE SYSTEMS,” the disclosure of which is incorporated herein by reference in its entirety.

### BACKGROUND

### Technical Field

Embodiments of the subject matter disclosed herein generally relate to a viscosity sensor and a method for measuring in real-time the viscosity in a tubular conduit, and more particularly, to a viscosity sensor that uses a microchannel that provides laminar flow regardless of the flow type in the tubular conduit.

### Discussion of the Background

Monitoring a fluid's viscosity is essential for industries transporting fluids through tubes or similar conduits, like pipes. Most of the petrochemical and chemical industries rely on transporting a variety of chemicals, having different viscosities, from one location to another location along pipes. The energy necessary for transporting a chemical through the pipe is usually provided by pumping systems. It is important to plan the pumping systems and select the required initial pressure to transfer the fluid from one location to another as the energy necessary for moving a given fluid along a certain pipe depends, inter alia, by the viscosity of the fluid. The more viscous the fluid is, the more energy is necessary to move that fluid. Not providing enough energy for the transportation process may result in loss of production, or even damaging the pumping system.

In other industries, the viscosity of a manufactured product is indicative of the quality of that product. For example, a milk in a container that has a varying viscosity is indicative of a low-quality product. Thus, a viscosity analysis is employed to ensure product consistency. The viscosity analysis serves as a quality indicator within the industrial production process, such as in petrochemical, polymers, and food industries.

Capillary, falling-object, and torque detection are various known and reliable techniques for measuring the viscosity of a fluid using an off-line workstation setup. The conventional approach for determining the viscosity of a product for many industries starts with an on-site sample collection, followed by laboratory analysis, and sometimes requiring samples preparation before the examination, and ends with sending the results' report to the site for decision making. This traditional process is time consuming and inefficient for the rapid industrial growth with their increasing demands. Continuing with the example discussed above, if the operator of the milk plant determines that the container of milk is of poor quality, only after this lengthy process has been performed, it will result in many other containers of milk being manufactured to have the same poor quality, and thus, will result in a substantial material loss for the plant.

Therefore, reliable, real-time viscosity sensors for tubular systems are desires for many industries to allow adequate production controls and reduce costs through accurate decisions, decrease production errors, and lower fluid waste.

There are many existing viscometers for real-time monitoring in tubular systems. The available viscosity sensors for this purpose are classified into three categories according to their operating principles. The viscosity sensors are based on (1) vibration or (2) rotation of a probe, or on (3) change in fluid velocity-based measurements [1, 2, 3]. The vibrational and rotational viscometers are large and rigid instruments that interfere with the flow of the liquid in the tubular system and disturb the fluid flow creating a pressure drop and energy loss. Also, some of these sensors use destructive methods that require access through the pipe to the fluid, leaving behind permanent damage to the pipe.

The viscometers based on the change in the fluid's velocity or pressure drop uses a simple and inexpensive measurement process, which is based on the Hagen-Poiseuille law. It can be a non-invasive and non-destructive method by selecting the appropriate viscosity sensors [4] to measure the change in the velocity profile, such as using probes attached to the outer surface of the pipe as the ultrasonic or electromagnetic sensors. The main drawback of this technology is the restriction of its operation to the laminar flow condition for the fluid that flows into the conduit. Hence, there is still a demand for developing reliable in-line viscometers to meet industrial needs and to be applicable to any kind of flow.

To address this need, real-time viscometers have been robustly established and well developed for microfluidic monitoring applications. MEMS, micro-resonators, and fluid velocity-based measurements are common types of real-time microfluidic viscometers [5, 6]. These sensors are optimized particularly for microfluidic applications, where the MEMS and micro-resonators are suitable for small volumes of fluid. Optical measurements, as employed by some of these sensors, require transparent materials. The fluid velocity-based viscometers, which are known as micro-capillary sensors, are limited to the laminar flows, where such flow is ensured in the microfluidics because of the small cross-section area of the microchannels. In micro-capillary viscometers, the fluid's velocity is determined by recording the time necessary for the fluid to pass from one point to another, in a channel having known dimensions, by microscopic video recording [5, 7] or using optical sensors [8]. From these measurements, the fluid flow rate is obtained based on the pressure drop approach using either micro-pressure sensors as in MEMS based sensors [9, 10] or capacitive sensors [11] distributed along the channel. Such micro-capillary viscometers have been utilized for industrial on-site analyses to provide near real-time viscosity results, and the system was supported with a pumping system, for example, the commercial handheld product Viscosity-rheometer-on-chip (VROC) for testing manually withdraw fluid samples [12]. However, even these sensors are still complex and may not provide fast enough results.

Thus, there is a need for a new viscosity sensor that overcomes the above noted deficiencies, is inexpensive, accurate, and appropriate for being located in any type of conduit.

### BRIEF SUMMARY OF THE INVENTION

According to an embodiment, there is a viscosity sensor for measuring a viscosity of a fluid flowing in a pipe. The viscosity sensor includes a base made of a flexible material, a bridge made of a rigid material, wherein the bridge is attached to the base to form a microchannel, a pressure sensor formed within the base, and a controller configured to receive a signal indicative of a capacitance change ΔC from the pressure sensor, and to calculate the viscosity of the fluid flowing through the microchannel based on the received capacitance change ΔC.

According to another embodiment, there is a viscosity sensor system for measuring a viscosity of a fluid flowing in a pipe. The viscosity sensor system includes a viscosity sensor having a base made of a flexible material, a bridge made of a rigid material, where the bridge is attached to the base to form a microchannel, and a pressure sensor formed within the base, a controller configured to receive a signal indicative of a capacitance change ΔC, from the pressure sensor, and to calculate the viscosity of the fluid flowing through the microchannel based on the received capacitance change ΔC, and a power source configured to supply electrical power to the pressure sensor.

According to yet another embodiment, there is a method for measuring a viscosity of a fluid flowing through a pipe. The method includes a step of attaching a viscosity sensor to an inside of the pipe, the viscosity sensor having a base made of a flexible material that directly attaches to the inside of the pipe, a bridge made of a rigid material, wherein the bridge is attached to the base to form a microchannel, and a pressure sensor formed within the base, a step of flowing the fluid through the pipe so that part of the fluid flows through the microchannel, a step of measuring a change in a capacitance associated with the pressure sensor, as the fluid flows within the microchannel, and determining the viscosity of the fluid flowing through the pipe based on the measured change in capacitance of the pressure sensor, within the microchannel.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a viscosity sensor, which is placed inside of a pipe, for measuring a viscosity of a fluid flowing through the pipe;

FIG. 2 illustrates various elements of the viscosity sensor;

FIG. 3 is a cross-section of a microchannel used by the viscosity sensor for measuring the viscosity of the fluid;

FIG. 4 shows a pressure sensor formed within a base of the viscosity sensor for measuring a pressure within the microchannel;

FIG. 5 shows a relationship between a total pressure inside a pipe and a viscosity of a fluid flowing through the pipe;

FIG. 6A is a graph showing a pressure of the fluid flowing through the microchannel versus the viscosity of the fluid flowing through the microchannel, and FIG. 6B is a graph showing a relationship between the total, dynamic and static pressures inside the microchannel versus the viscosity of the fluid;

FIGS. 7A to 7D illustrate a manufacturing process of the base and pressure sensors of the viscosity sensor, and of a bridge that is added to the base to form the microchannel, and FIG. 7E shows a cross-section through the obtained viscosity sensor;

FIG. 8 shows a setup for testing the manufactured viscosity sensor;

FIGS. 9A and 9B illustrate the relationship between the measured relative capacitance of the viscosity sensor and the viscosity of the fluid within the pipe;

FIG. 10 illustrates a viscosity sensor system in which the viscosity sensor communicates with an external device through a wire that extends through the wall of the pipe in which the viscosity sensor is located;

FIG. 11 illustrates another viscosity sensor system in which the viscosity sensor communicates with an external device in a wireless manner through the wall of the pipe in which the viscosity sensor is located;

FIGS. 12A to 12C illustrate the signal received from various pressure sensors of the viscosity sensor system, at the external device, using the wireless implementation; and

FIG. 13 is a flow chart of a method for measuring a viscosity of a fluid in a pipe with a viscosity sensor having a microchannel disposed inside the pipe.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a viscosity sensor having a flexible base and the entire sensor is placed inside a tubular pipe and measures a pressure inside the sensor. However, the embodiments to be discussed next are not limited to a flexible base viscosity sensor, or to a sensor that is placed inside a tubular pipe, but they may be applied to a rigid sensor and/or to a pipe having any profile.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a new velocity-dependent viscometer or viscosity sensor using a novel design for real-time measurements with insignificant flow disruption is introduced. The viscosity sensor may use, in one implementation, a poly(methyl-methacrylate) (PMMA) microchannel bridge, that forms a microfluidic channel when attached to a mechanically flexible polydimethylsiloxane (PDMS) base, and the entire structure is connected to the inner surface of a pipe. The flexible base of the viscosity sensor naturally adapts to different pipes diameters and curvatures shapes. Forcing part of a fluid flowing in a pipe system to flow through the microchannel formed by the bridge with the base, provides a laminar flow inside the microchannel, regardless of the flow type in the pipe system. Also, this viscosity sensor uses the pipe flow's driving force to propel the fluid flow into the microchannel for measurement, without requiring a pumping system, or sample withdrawal. In one embodiment, a stand-alone viscosity sensor system is presented and the system is capable for wireless data transmission to an external device, e.g., a smartphone. The novel viscosity sensor can be developed with low-cost materials and a low-cost fabrication processes, to provide an affordable sensor. As the viscosity of a fluid is invers proportional to the microchannel flow rate for incompressible Newtonian fluids, and the microchannel flow rate is proportional to a change in pressure in the microchannel, by measuring the pressure or change in pressure in the microchannel, it is possible to calculate the viscosity of the fluid. This sensor and its operating principle are now discussed in more detail with regard to the figures. The pressure or change in pressure may be measured with one or more pressure sensors. While any kind of pressure sensor may be used, in one embodiment a capacitive pressure sensor is used for measuring the pressure inside the microchannel. Because of the small size of the microchannel (width less than 10 mm and height less than 500 μm), the capacitive pressure sensor is a good candidate. For a given pressure measurement, one or more pressure sensors may be used. For example, in one application, the readings from plural pressure sensors distributed along the length of the microchannel may be averaged and a single pressure value may be used for the calculation of the viscosity of the fluid flowing through the microchannel.

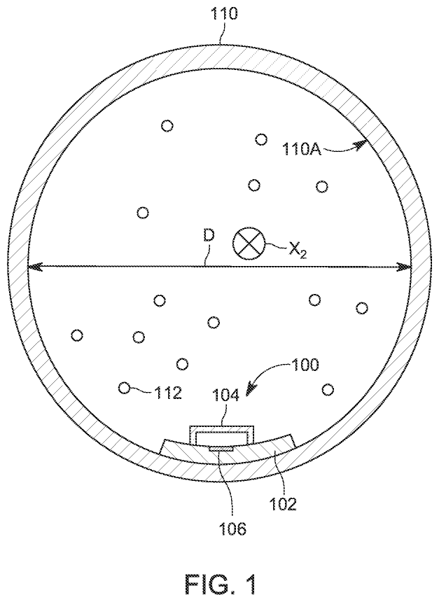

More specifically, as shown in FIG. 1, a novel fluid viscosity sensor 100 is placed inside a pipe 110 having an internal diameter D. The diameter D can be between a couple of mm (e.g., 1 cm) to any larger size. The viscosity sensor 100 has a base 102 that is placed on the internal surface 110A of the pipe 110, a bridge 104 attached to the base 102, and one or more pressure sensors 106 located in the base 102. While FIG. 1 shows the pipe 110 having a circular cross-section, the viscosity sensor discussed herein can be configured to work in a pipe having any transverse cross-section, e.g., rectangular, square, triangular, etc. The base 102 can be made of a flexible material, e.g., polydimethylsiloxane (PDMS), so that the base 102 follows intimately the profile of the internal surface 110A of the pipe 110. Other flexible materials may be used as long as they can bend/deform enough to follow the profile of the internal surface of the pipe. However, in another embodiment, the base 102 may be made of a rigid material, which does not follow the profile of the internal surface 110A, in which case a liquid pocket may be formed between the base and the internal surface of the pipe. The base may be made of a flexible material that has a high friction relative to the material of the pipe. In this way, the base may be simply placed within the pipe and the base adheres to the internal wall of the pipe so that no other means are required for attaching the sensor to the pipe. However, if desired, any type of connection means (e.g., glue, screws, etc.) can be used to attach the base of the sensor to the internal pipe of the wall. A thickness of the base may be a few mm or less.

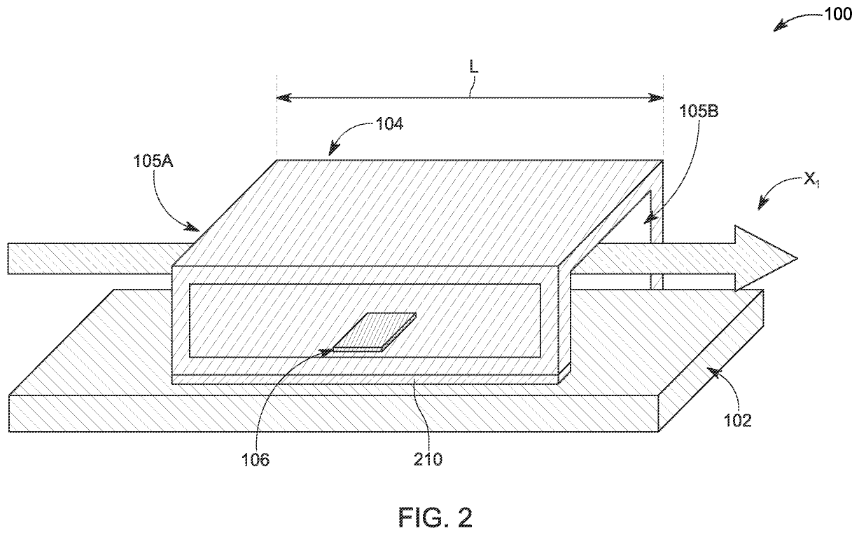

The viscosity sensor 100 is shown in FIG. 2 as extending along a longitudinal axis X1, which is parallel to the longitudinal axis X2 (shown in FIG. 1 as entering the page) of the pipe 110. For simplicity, the pipe 110 is omitted in FIG. 2. The base 102 is shown in this figure as being flat, and having a footprint larger than the bridge 104. The bridge 104 is made of a rigid material, for example, poly(methyl-methacrylate) (PMMA), so that an external pressure exerted by the fluid 112, which flows through the pipe 110, on the bridge, does not deform the walls of the bridge. This condition is desired because the pressure sensor 106's readings should be indicative of only the liquid's pressure inside the bridge, and not be influenced by the liquid pressure outside the bridge. Although FIG. 2 suggests that the length of the bridge 104 is less than the length of the base 102, that is not required for this configuration to work as a viscosity sensor. One skilled in the art would understand that it is possible to make the bridge 104 longer than the base 102, for which situation the bridge 104 is placed in direct contact with the internal surface of the pipe 100, and the base 102 covers the bridge and holds it in place relative to the pipe 110. Such arrangement still allows the fluid 112 in the pipe 110 to flow through the microchannel formed between the base and the bridge, and the base to follow the profile of the pipe.

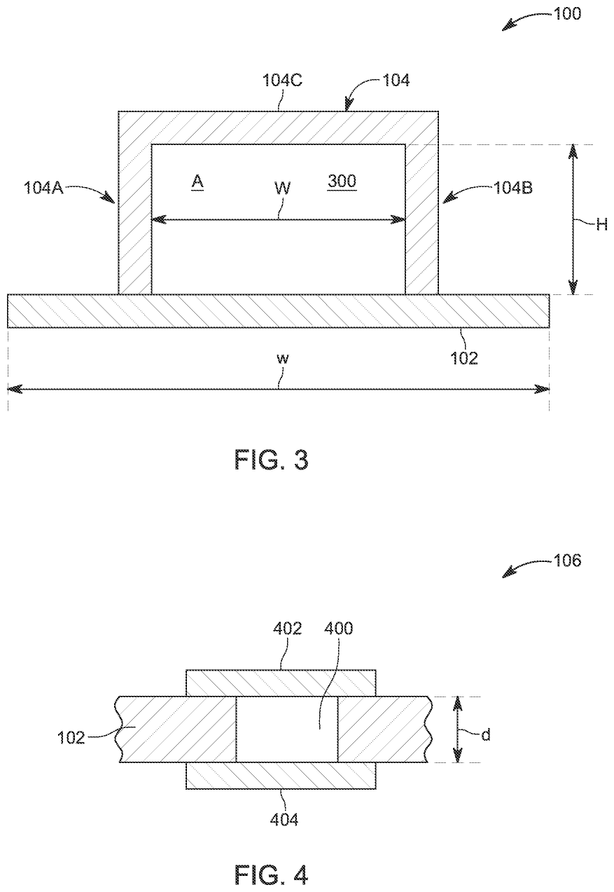

FIG. 3 shows a cross-sectional view of the base 102 and the bridge 104. The bridge 104, when attached to the base 102, forms an enclosed volume, which defines the microchannel 300. The bridge 104 has two side walls 104A and 104B, and a top wall 104C in this embodiment. However, the bridge may be made to have a different transversal cross-section, for example, part of a circle, ellipse, a triangle, etc. There is no bottom wall for the bridge, and thus the name “bridge” for this part of the sensor. The two side walls and the top wall define the trench or microchannel 300. The sizes of the microchannel are the height H, the width W, and the length L. The height H is selected to obtain the microchannel 300, i.e., a channel for fluid flow which is in the micrometer range. More specifically, the microchannel 300 has a height H between 100 and 500 μm, with a preferred size of substantially 250 μm. The term substantially is defined herein to include any variation of the height within +1-10% of the given value. The width W of the microchannel 300 is selected to be about 3 mm and the length L is selected to be between 3 to 100 mm, with a preferred length of about 60 mm. It is noted that a channel that has the height H larger than 500 μm would likely not work with the concept to be discussed later. A cross-section area A of the microchannel 300 is square in FIG. 3, but other shapes may be selected as discussed above.

The bridge 104 is made to be solid and have no openings, except for the input 105A and the output 105B. This means that the bridge 104 is attached to the base 102, for example, with a glue 210 or other materials or methods, so that no fluid enters or exits the microchannel 300 except for the input 105A and the output 105B. The bridge 104 may be attached to the base 102 by other means, e.g., mechanical means, thermal means, etc. The width W of the bridge is shown in FIGS. 2 and 3 to be smaller than the width w of the base 102. In one application, the width W is much smaller than the width w, i.e., it can be a couple of times (2 to 10) smaller. This situation happens when it is desired that the width w of the base 102 to be almost the same as the internal circumference of the surface 110A of the pipe 110. By making the width w of the base so large, it is possible to fix the viscosity sensor to the internal surface of the pipe due exclusively to the natural adherence properties of the PDMS material, i.e., without using a glue or a mechanical means.

The pressure sensor 106 is shown in FIG. 4 having a top electrode/plate 402 and a bottom electrode/plate 404 and these two plates sandwich a hole 400 formed into the base 102. The hole 400 may be filled with air or with any other dielectric material. The two electrodes 402 and 404 and the air pocket 400 act as a capacitive pressure sensor, so that when the fluid inside the microchannel 300 has a higher pressure than the air inside the hole, it squeezes the top plate 402 toward the bottom plate 404, which results in the dielectric air gap 400 being reduced. This change in the thickness of the dielectric material can be measured with corresponding electronics (e.g., a controller as discussed later) and can be associated with the pressure exerted by the fluid 112 on the pressure sensor 106, as discussed later. More than one pressure sensor may be formed in the base 102 to improve the pressure reading's accuracy. Note that the pressure sensor 106 may have one electrode directly exposed to the fluid flowing through the microchannel 300 and also that electrode is fully formed within the microchannel 300. In one application, that electrode may be protected from the fluid by being covered with a thin polymeric layer, also discussed later.

The viscosity sensor illustrated in FIGS. 1 to 4 does not require an external flow path or tube contractions to prevent fluid flow interruption, pressure drop, and/or energy loss. Instead, the viscosity sensor uses the volumetric flow rate generated inside the tubular system 110 to drive a small fluidic volume inside the microchannel 300 for volumetric flow rate and/or viscosity measurements under the laminar flow condition using the microfabrication advantages. In other words, the viscosity sensor 100 uses exclusively the microchannel 300 for performing a pressure measurement of only the fluid flowing through the microchannel and from this information, estimates the flow rate and/or the viscosity of the fluid 112 flowing inside the pipe 110.

As previously discussed, the base of the viscosity sensor is made as a physically flexible platform to adapt to different pipe diameters and curved architectures. The designed viscosity sensor's base, which is made of PDMS in this embodiment, has excellent physical and chemical properties since it is compatible with the microfabrication process, provides high flexibility, thermal stability, and is a low-cost material. The PDMS base contains one or more pressure sensors 106, which are based on a capacitive mechanism. The capacitive pressure sensor 106 was selected among other pressure sensing technologies because of the high stability and reliability even under mechanical deformations and it can be tailored easily for different sizes as appropriate for a variety of sensing pressure ranges. Therefore, it can provide good sensitivity to the flow's pressure for different pipe diameters and bending radii. The PDMS base may be patterned to include the encapsulated air 400, which is used as the dielectric material for the pressure sensor, and which is sandwiched between sputtered copper layers 402 and 404 on the PDMS base, which act as the conductive parallel plates for the capacitive structure.

The rigid microchannel bridge 104 is installed on top of the capacitive pressure sensor 106 on the base 102 to form the fluidic microchannel 300 because it is not possible, in large scale cross-section areas, i.e., for pipes, to measure the flow rate directly using the pressure change in the pipe. Because the static pressure generated by the fluid's weight inside the pipe 110 is much higher than the dynamic pressure generated by the fluid flow, by creating the microchannel 300, the size of the static pressure term is reduced, to be less than the dynamic pressure term. Note that the static pressure is multiplied by the microchannel height (which is less than 500 μm), and the dynamic pressure is divided with the square of the cross-section area A of the microchannel 300 (the area is very small, which makes the dynamic pressure large). Therefore, the bridge 104 provides a small cross-section area A regardless of the pipe 110's dimensions, which makes the dynamic pressure to dominate over the static pressure. For this reason, the microchannel 300 is made of a solid material, e.g., PMMA but other materials may also be used, to avoid channel deformation under different applied pressures from the surrounding fluidic environment. Also, the PMMA material is compatible with the PDMS base and the microfluidic fabrication processes.

The design of the microchannel 300 with micro-sized height H and a rectangular cross-section area offers a negligible flow disturbance in the pipe, compared to the existing technologies that generate large pressure drops and/or energy losses due to their large size. Another advantage of the microchannel 300 is the formation of a constant cross-section area A regardless of the pipe's dimensions. This means that no special correction of the measured viscosity is needed for measurements performed in pipes with different diameters. Moreover, the Reynold number is small for the microchannel 300 because it is proportional to its height. Therefore, the microchannel provides a laminar flow irrespective of the flow type in the pipe 110. The laminar flow simplifies the overall system physics and mathematical equations used for calculating the flow rate and/or the viscosity.

The operating principle of the viscosity sensor 100 is now discussed in more detail. The capacitive pressure sensor 106 inside the microchannel 300 is placed to measure the absolute pressure Pₜₒₜₐₗ generated by (1) the fluid's weight and (2) the fluid flow's velocity inside the microchannel 300. The measured pressure using the capacitive pressure sensor 106 corresponds to the total pressure P_{Total}, which is a combination of the static pressure P_{Static} and the dynamic pressure P_{Dynamic}, as expressed in equation (1).

P_{Total}=P_{Static}+P_{Dynamic}. (1)

The dynamic pressure P_{Dyamic} is proportional to the square of the volumetric flow rate Q of the fluid, as expressed in equation (2), while the static pressure P_{static} is proportional to the high of the microchannel 300.

$${P}_{T otal} = ρ g H + \frac{1}{2} ρ \frac{{Q}^{2}}{{A}^{2}} , \qquad ( 2 )$$

where ρ is the fluid's density, H is the microchannel 300's height, and g is the gravity acceleration.

The total pressure is measured using the capacitive pressure sensor 106, where its capacitance value is proportional to the applied pressure, as shown by equation (3):

$$C = \frac{{ɛ}_{0} {ɛ}_{r} {A}_{1}}{d} , \qquad ( 3 )$$

where d is the thickness of the base 102 (see FIG. 4), which also coincides with the thickness of the dielectric pocket of air 400, εᵣ is the dielectric relative permittivity of the material (air in this case), ε₀ is the permittivity of the free space (8.854×10¹² F/m), and A₁ is the area of the conductive parallel plates 402, 404, which have the sizes of 3 mm×3 mm in this embodiment. Other sizes and shapes may be used.

When the pressure exerted by the fluid 112 inside the microchannel 300 increases, the dielectric layer's height d decreases, and thus the capacitance C value of the pressure sensor 106 increases. Thus, based on the readings from the capacitor, it is possible to calculate the pressure inside the microchannel 300 or the flow rate of the fluid, as these quantities are related to each other through the equations (1) to (3). Knowing the exact profile of the microchannel 300 and also the profile and sizes of the pipe 110, it is then possible to link the pressure readings to the flow rate Q within the pipe 110.

The change in the microfluidic flow rate Q is measured using the capacitive pressure sensors 106 in the microchannel 300. The capacitance measurements and the absolute pressure are proportionally related, as recognized from the capacitive pressure sensors [13]. Therefore, a change in the fluid viscosity is inversely proportional to the capacitance measurements due to the variation in the fluid flow rate.

In this regard, the fluid viscosity p in the pipe 110 is inversely proportional to the microfluid flow rate Q in the microchannel 300. Equation (4) expresses the relationship between the viscosity and the flow rate using the Hagen-Poiseuille law for the microchannel having a rectangular cross-section, where W is the microchannel width, H is the microchannel depth, and ΔP is the pressure difference between two points separated by a length l:

$$Q = \frac{Δ P {W}^{2} {H}^{3}}{12 μ l ( W + H )} . \qquad ( 4 )$$

Thus, by measuring the pressure difference ΔP and the flow rate Q through the microchannel 300, it is possible to calculate the viscosity μ of the fluid flowing through the pipe 110. The pressure difference ΔP can be measured by placing two pressure sensors 106 in the base 102. The fluid flow rate Q through the microchannel 300 can be calculated based on equation (2) based on a single pressure reading (as the dynamic pressure is directly related to the dynamic pressure). Alternatively, as all these quantities are related to each other by equations (1) to (4), it is possible to expose the sensor 100 to various fluid flows and map the pressure readings inside the microchannel 300 to the viscosity of the fluids run through the microchannel and store this correspondence in tables associated with the various fluids. Then, when the viscosity sensor 100 is distributed in an actual piping system, the controller that receives the pressure readings from the sensor uses these tables to identify the actual viscosity for a given fluid that corresponds to the measured pressures. This approach was tested as now discussed.

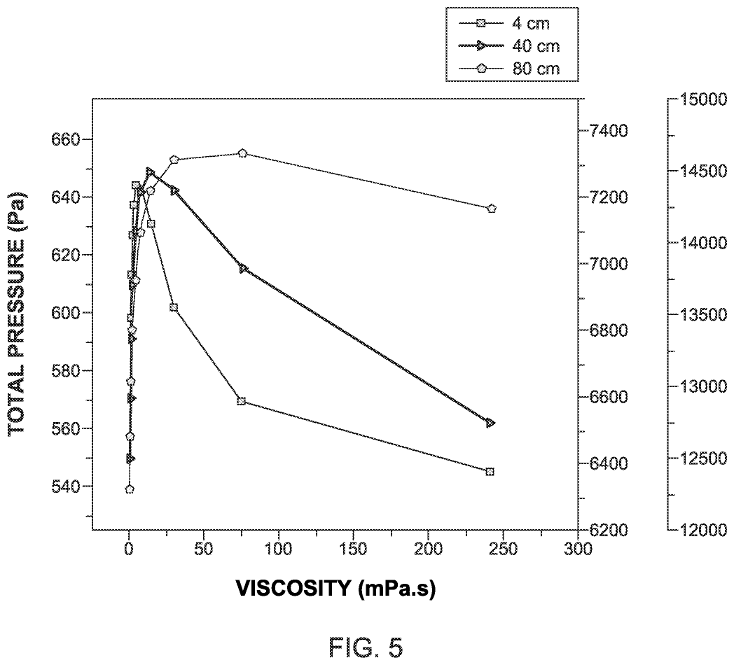

The simulated capabilities of the viscosity sensor 100 were studied using a numerical analysis performed with a commercially available tool. The numerical analysis was performed to understand the microchannel's effect on the readings, to consider the effect of its depth on the device performance, to assure fully developed flow conditions inside the microchannel, and also to understand the relationship between the fluid viscosity in the tubular system 110 and the flow rate and associated pressures in the microchannel 300. For this analysis, first, the pressure behavior of various pipes was analyzed without the microchannel 300. Tubes having a length of 30 cm and various diameters have been tested using a variety of fluid viscosities at a fixed flow rate equal to 2,000 ml/min. The pressure measurements were recorded at an individual point located on the base, at the middle point of the tube's length. FIG. 5 shows the effect of the pipe diameter on the measured pressures at the selected position, with different viscosity ranges. Each tube diameter has a different diagram performance that varies with the viscosity and the pressure ranges because the static pressure increases with the pipes' depths. Therefore, using the microchannel 300 in the tube 110 provides uniform pressure range and behavior with the viscosity depending only on the microchannel flow rate and its constant depth.

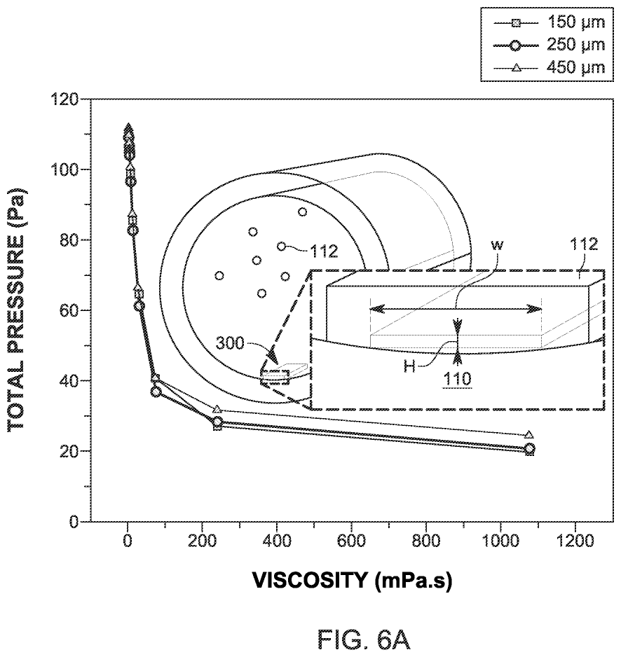

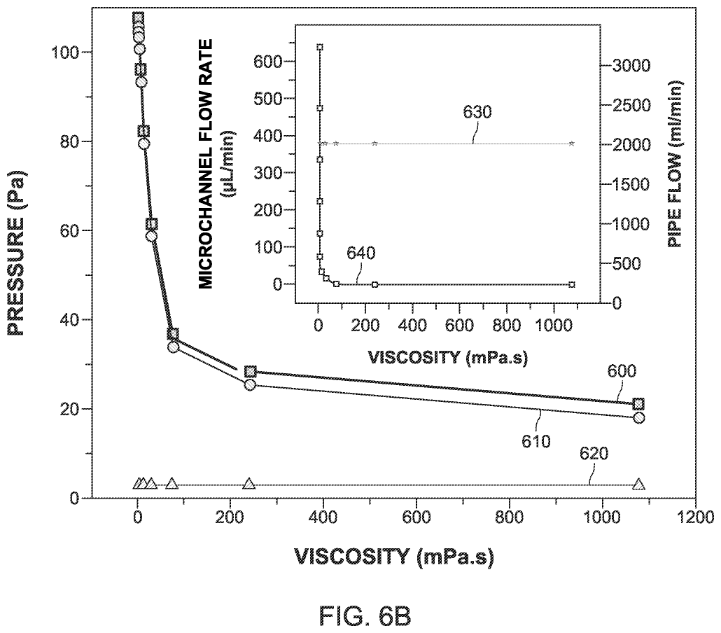

In contrast to the results of FIG. 5, the measurements illustrated in FIG. 6A indicate the microchannel 300′ depth effect on the viscosity sensor's performance at a measured point located in the center of the microchannel. The base 102 of the microchannel 300 was connected, for this simulation, to the internal wall of a 4 cm diameter pipe 110, with a fixed flow rate of the fluid. The results in FIG. 6A show a consistent viscosity sensor performance for different microchannels heights H (150, 250, and 450 μm), with a dramatic decrease in the measured pressure with the viscosity of the fluid. At higher fluid viscosities, the volume of the fluid driven in the microchannel decreases, as well as the absolute pressure, for which the dynamic pressure dominates over the static pressure. At high viscosities, the flow rate and the dynamic pressure become too low, and the static pressure becomes dominant particularly for the higher channels, as shown in the graph for the microchannel having the 450 μm height. The microchannel 300 may have any height between 100 and 500 μm.

FIG. 6B illustrates the absolute pressure 600 measured in the microchannel 300, at the same conditions as in FIG. 6A, but using a 250 μm channel depth. The total pressure 600 is almost equal to the dynamic pressure 610 and thus, the static pressure 620 measurements are negligible compared to the dynamic pressure 610. Also, the dynamic pressure behavior is following the trend of the microchannel flowrate 640, as illustrated in the inset of FIG. 6B. The inset also shows the flow rate 630 through the pipe 110.

Note that for these measurements, the viscosity sensor 100 was placed into the tube 110 so that the microchannel 300 has its longitudinal axis X1 parallel to the longitudinal axis X2 of the tube 110. This arrangement is also used when the actual viscosity sensor 100 is placed into an actual tube or pipe. FIG. 6A shows, at scale, the extremely low profile (i.e., height) of the microchannel 300 relative to the pipe 110.

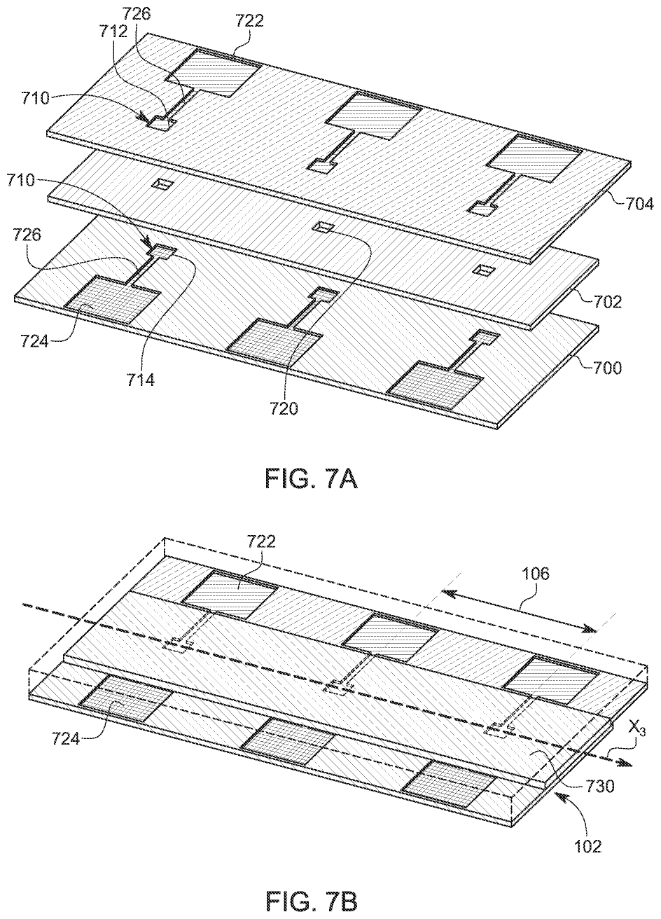

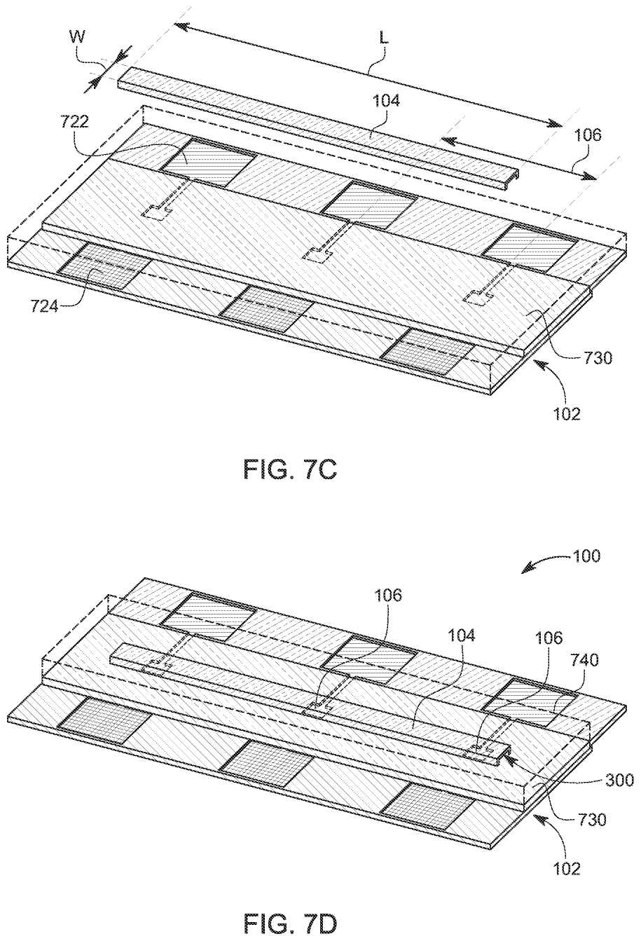

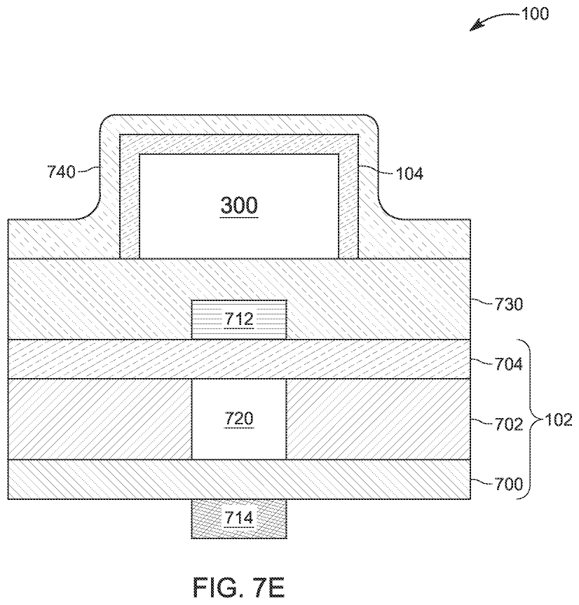

Based on these observations, the viscosity sensor 100 has been manufactured as now discussed. In this embodiment, the viscosity sensor 100 was manufactured with a lithography-free process making it a low cost, simple and affordable device. Other processes may be used to manufacture the viscosity sensor. The viscosity sensor has two parts, which are the rigid PMMA microchannel bridge 104 and the PDMS mechanically flexible base 102, with at least one capacitive pressure sensor 106 as discussed above. The physically flexible base 102 was fabricated as shown in FIGS. 7A and 7B, using three PDMS layers 700, 702, and 704. In one application, each of the PDMS layers 700, 702, and 704 has a 500 μm thickness. Other values may be used for the thickness. Kapton tape may be used as a shadow mask on the first and third layers 700 and 704. The Kapton tape is placed to cover the entire surface of the layer and then it is patterned using a CO₂ laser to form 3 mm squares, which may be aligned along a longitudinal line X3 formed in the middle of the layers 700 and 704. These squares correspond to squares 710 on the first and third layers as shown in FIG. 7A. The patterned squares of Kapton tape are then peeled off from the surfaces of the two layers to form corresponding active areas for the capacitance pressure sensors 106.

The exposed PDMS surfaces were treated with oxygen plasma to modify the surface from hydrophobic to hydrophilic, to increase the surface roughness to provide better metal adhesion on its surface. Then, the patterned squares on the two PDMS layers 700 and 704 were sputtered with 200 nm thickness of copper to form conductive plates 712, 714 for the capacitance sensors. Note that the plate 712 is formed on the top square 710 of the PDMS material for the layer 704 while the plate 714 is formed on the bottom square 710 of the PDMS material for the layer 700, in FIG. 7A. The Kapton tape was then completely removed from the PDMS layers 700 and 704, leaving the active areas with a thin coated layer 712 and 714 of copper, which correspond to plates 402 and 404.

The second PDMS layer 702 was patterned all the way through the PDMS layer thickness using the CO₂ laser to form trenches or holes 720. These trenches are filled by air, which performs as a dielectric material for the capacitance sensors 106. The three prepared PDMS layers 700, 702, and 704 were arranged in the order shown in FIG. 7A and then the layers were assembled and bonded together, as shown in FIG. 7B, using an oxygen plasma technique by exposing the surfaces to oxygen plasma for 60 seconds followed by bringing the surfaces together. The bonds were enhanced by baking the bonded layers for 60 seconds at 80° C. Copper electrodes 722 and 724 were bonded to the flexible plates 712 and 724, respectively, using a silver paste 726. After curing the silver paste, the entire assembly was packaged using a PDMS layer 730 to protect the copper electrodes 712 and 714, and to fix the positions of the layers 700, 702, and 704 to prevent air leaking.

Next, the microchannel bridge 104 was fabricated, as shown in FIG. 7C. The microchannel bridge 104 was fabricated using a 1 mm thickness PMMA sheet. The sheet was patterned using the CO₂ laser to form a 250 μm trench depth into the rectangular shaped piece of the sheet, the rectangular shaped piece having a 3 mm width and a length of up to 60 mm, as also shown in FIG. 7C. Then, the rectangular shaped piece was cut off from the sheet to obtain the bridge 104 with the trench. After that, the microchannel bridge 104 was attached to the prepared, flexible sensory base 102 using the oxygen plasma bonding method, to obtain the microchannel 300, and essentially the viscosity sensor 100, as shown in FIG. 7D. To ensure a good bonding between the bridge 104 and the base 102, the viscosity sensor 100 can be repackaged with a thin PDMS coat 740. A transversal cross-section of the viscosity sensor 100 obtained with the method discussed herein is shown in FIG. 7E.

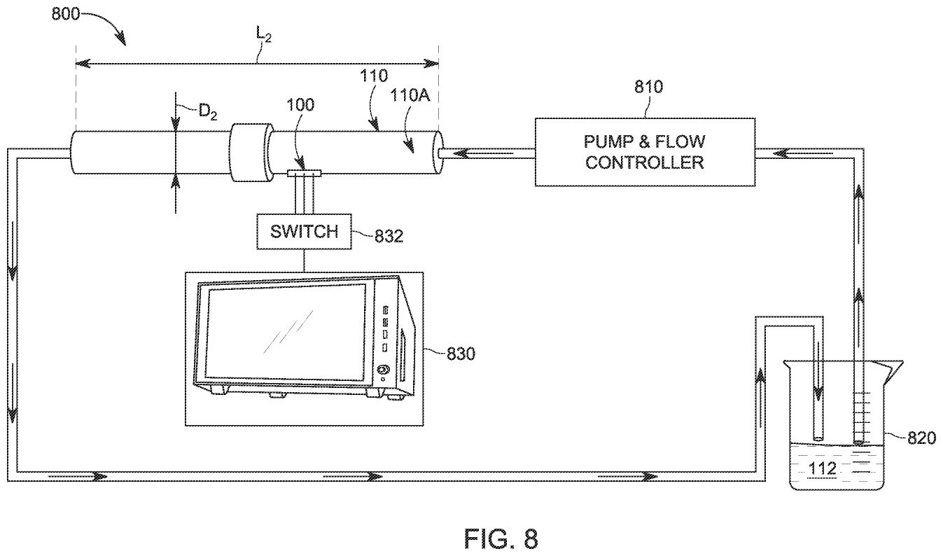

For characterizing the viscosity sensor 100, a transparent polyvinyl chloride (PVC) pipe system 800 was built with a 3.8 cm inner diameter D2 and a 60 cm total system's length L2, as shown in FIG. 8. The viscosity sensor 100 was attached to the inner wall 110A of the pipe 110. The viscosity sensor 100 was characterized using a pump controller 810 (Catalyst FH100DX Pump), which generates a precise flow rate. The pump was connected to the pipe system and to a fluid reservoir 820. The viscosity sensor 100 was tested with different fluid 112 viscosities at a steady flow rate of 2,000 ml/min. For each fluid, the system was run for 1 minute to stabilize the selected viscosity before collecting data. At each viscosity, the capacitance was recorded from the pressure sensors 106 using a general-purpose source meter 830, for example, a Keithley 2400A-SCS.

The viscosity sensor 100 was tested with diverse fluids viscosities. Volume-diluted glycerol solutions and lubricant oils, with the international standards organization viscosity grade (ISO VG), were used to characterize the sensor at the different viscosities with pre-known values. 2L of liquid samples were applied for each viscosity test to fill the pipe, pumping tubes, and leave some liquid in the reservoir for pumping. The capacitance of the pressure sensor was measured with the multimeter 830 at each running fluid, and a switch 832 was used to alter between different capacitor sensors 106 present in the base 102. A quantity ΔC/C₀ was calculated for each measured capacitance to determine the change in the capacitance in response to the difference in the microfluidic flow rate due to the transformation of the fluid viscosity, with C and C₀ being the capacitance values with and without the applied pressure.

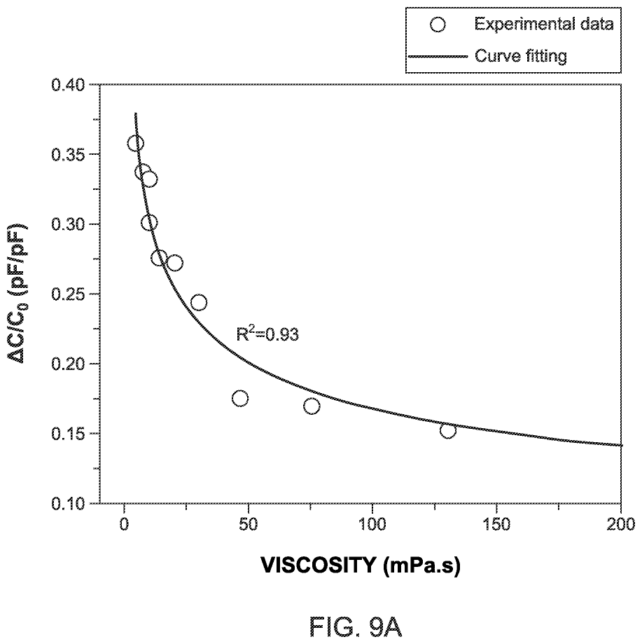

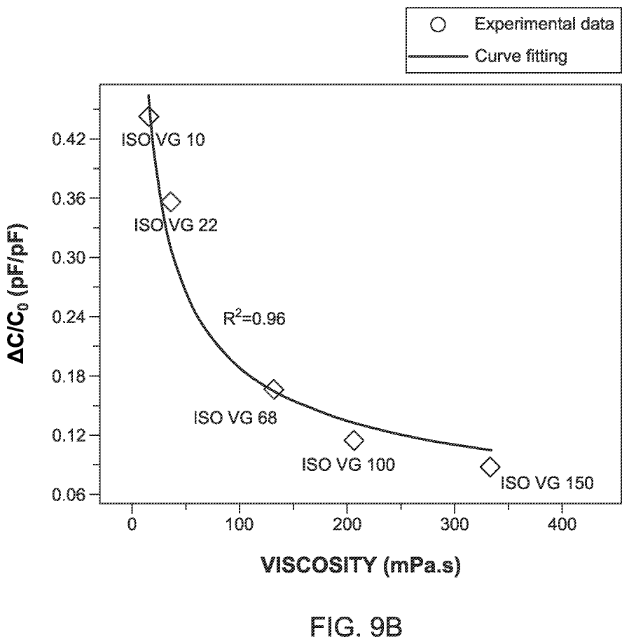

FIGS. 9A and 9B present the viscometer characterization results for a capacitor sensor located in the center of the microchannel base. The results for the diluted glycerol solutions (shown in FIG. 9A) and for the lubricant oils (shown in FIG. 9B) show similar behaviors. The capacitance pressure sensor 106, representing the microchannel flow rate, is inversely proportional to the fluid's viscosity, as the numerical analysis indicates. The viscous fluids have a lower drive force to flow the fluids into the microchannel 300 at a steady pipe flow, causing a decrease in the microfluidic flowrate, which is translated into a reduction in the capacitive measurements. For these measurements, the capacitive sensor's readings were calibrated prior to the measurements with known pressures so that a unique mapping can be established between a capacitive reading and a corresponding pressure. The capacitive pressure sensors were characterized using the multisource 830 for different water depths. From these measurements, it can be seen that by reading the change in the capacitance of the sensor 106 while within the microchannel 300, it is possible to uniquely calculate the corresponding viscosity of the fluid flowing inside the microchannel 300.

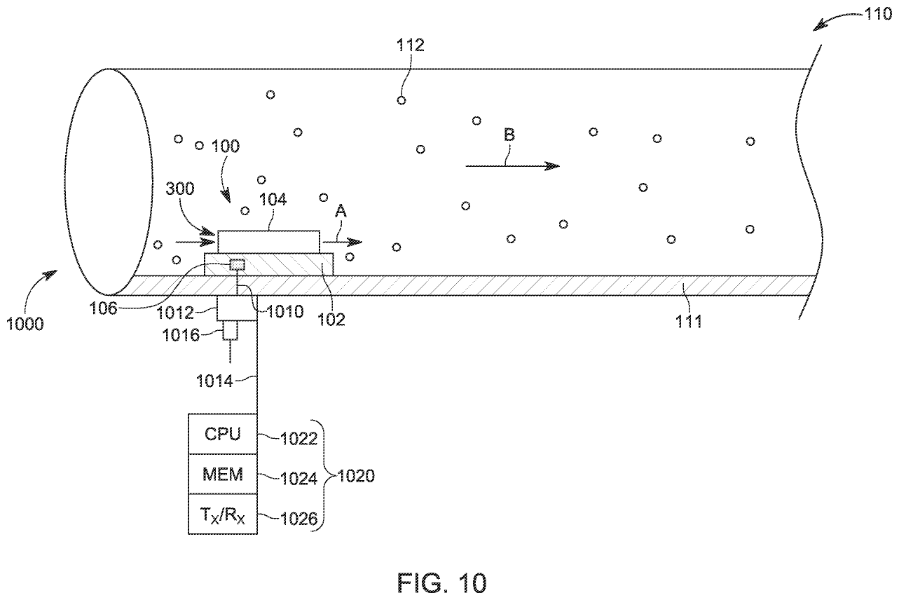

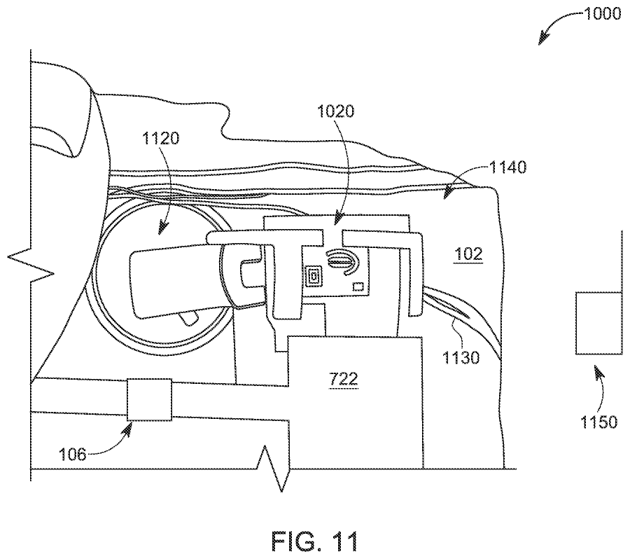

The viscosity sensor 100 has been shown in the above embodiments as being placed inside the pipe 110 with no wires leaving the sensor. However, for the viscosity sensor to exchange data (capacitive readings) with an external controller, either a wired communication or a wireless communication needs to be established between the one or more pressure sensors 106 and the controller. Both implementations are possible and both are now discussed with regard to FIGS. 10 and 11. FIG. 10 shows the wired implementation of a viscosity sensor system 1000 in which one or more wires 1010 extend through the wall 111 of the pipe 110, from the viscosity sensor 100 to a connection box 1012. The connection box 1012 may include electronics for facilitating data exchange between the viscosity sensor and an external controller 1020. The figure also illustrates the fluid flow A through the microchannel 300 and the fluid flow B through the pipe 110. If the connection between the pressure sensor 106 and the controller 1020 (which can include a processor 1022 and a memory 1024) is fully wired, then additional wires 1014 electrically connect the connection box 1012 to the controller 1020. Alternatively, it is possible that the connection box 1012 includes a transmitter or transceiver 1016 that communicates in a wireless manner with a corresponding transceiver 1026, which is part of the controller 1020. The two transceivers may use any protocol and any frequency spectrum (FM, Wi-Fi, Bluetooth, etc.) for communication and data exchange. One or more of these devices may also be fitted with an appropriate power source to supply electrical energy to the transceivers. The embodiment illustrated in FIG. 10 can be implemented in any type of pipe, i.e., even a type made of a material that suppress electromagnetic waves from passing through the wall.

However, if the pipe 110 is made of a material that allows electromagnetic waves propagation through its walls, e.g., PVC, than it is possible to have the viscosity sensor 100 made to include a power source, the controller (e.g., a microcontroller) and a transmitter so that no wires are piercing the wall of the pipe. FIG. 11 shows the viscosity sensor system 1000 including the viscosity sensor 100, the microcontroller 1020 and a battery 1120 attached to the base 102. The battery 1120 is configured to supply power to the pressure sensor 106 and/or to the various elements of the microcontroller 1020. The figure also show one pressure sensor 106 and one of its terminal 722. Wires 1130 are visible and they are configured to link the pressure sensor 106 to the microcontroller 1020. For this embodiment, the viscosity sensor 100 was integrated with commercially available electronics to create a standalone functional system installed inside a pipe. In one application, a Bluetooth Low Energy (BLE) enabled Programmable System on Chip (PSoC) from Cypress™ can be used as the controller 1020. This controller has an internal capacitance to digital convertor (CDC) to connect one or more capacitive pressure sensors 106 to the controller without the need for additional Integrated Circuits (ICs), or passive components. The raw CDC values from the pressure sensors 106 can be converted into a capacitance unit using a calibration plot that is obtained prior to deploying the viscosity sensor. Furthermore, the PSoC has the BLE functionality built-in to enable sending the data wirelessly through the pipe 110. The viscosity sensor system 1000, which includes the viscosity sensor 100 and the controller 1020, is powered using a coin cell battery 1120 due to the advantage of the low power consumption of the chip. The battery 1120 can be replaced with an energy generation device that uses the fluid flow or other means to generate energy. The controller was connected to the pressure sensors with the wires 1130 and everything was packaged via a PDMS layer 1140 for insulation.

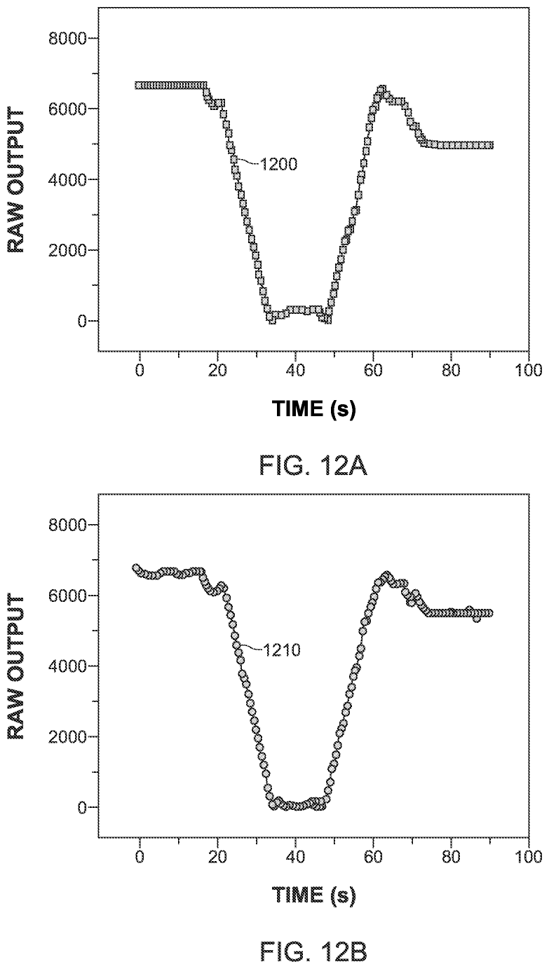

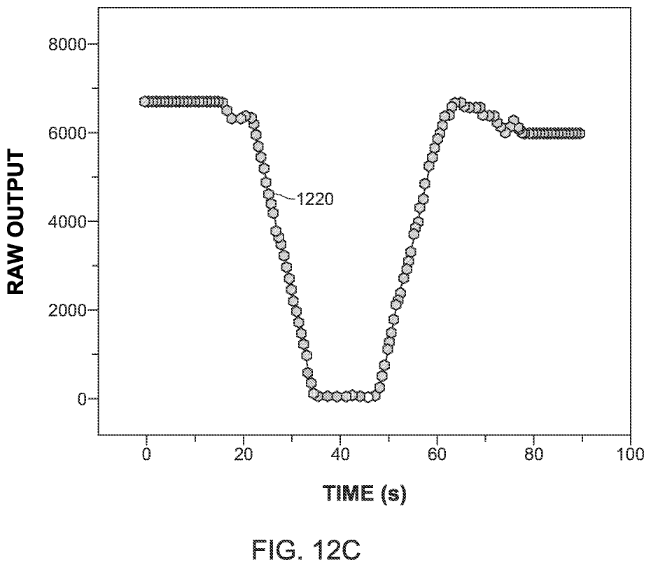

For a plastic pipe with 4 cm in diameter and filled with the fluid 112, the BLE can easily communicate with a mobile device 1150, e.g., laptop, tablet, smartphone, etc., up to 10 m in range. A test was performed with the viscosity sensor 100 being connected to the controller 1020, and the viscosity sensor was submerged in water up to 50 cm depths. The data measured by the pressure sensor was sent in real-time from three pressure sensors, placed in the microchannel, to the smartphone 1150. The curves 1200 to 1220 corresponding to the readings from the three pressure sensors 106 are shown in FIGS. 12A to 12C, respectively. It is noted that the three curves are similar to each other. It is also noted that only one pressure sensor is needed for measuring the flow rate through the pipe 110 and/or for determining the viscosity of the fluid. In this embodiment, three pressure sensors are used to improve the accuracy of the estimated flow rate and/or viscosity, and for redundancy.

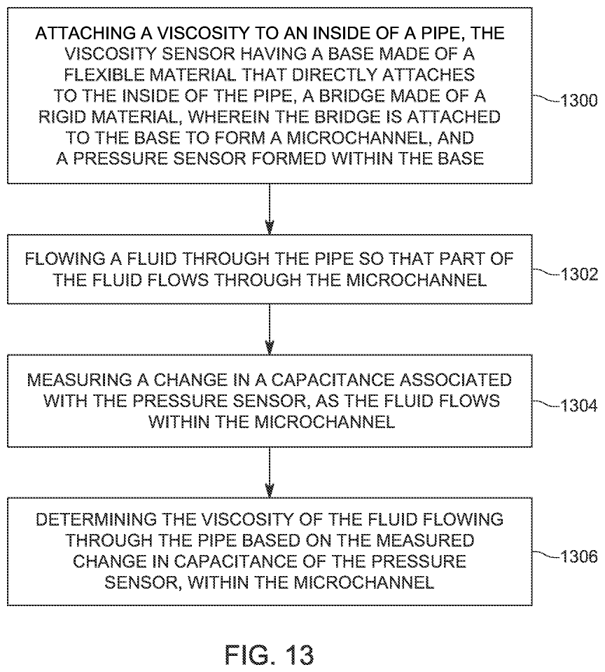

A method for measuring a viscosity of a fluid now discussed with regard to FIG. 13. The method includes a step 1300 of attaching a viscosity sensor 100 to an inside of a pipe 110, the viscosity sensor 100 having a base 102 made of a flexible material that directly attaches to the inside of the pipe 110, a bridge 104 made of a rigid material, where the bridge 104 is attached to the base 102 to form a microchannel 300, and a pressure sensor 106 formed within the base 102, a step 1302 of flowing a fluid 112 through the pipe 110 so that part of the fluid flows through the microchannel 300, a step 1304 of measuring a change in a capacitance associated with the pressure sensor 106, as the fluid 112 flows within the microchannel 300, and a step 1306 of determining the viscosity of the fluid 112 flowing through the pipe 110 based on the measured change in capacitance of the pressure sensor 106, within the microchannel 300.

The above embodiments disclose a new usage of a microfluidic viscometer that depends on the flow rate change to allow real-time monitoring of fluids' viscosity in pipe systems. The sensor's novel design provides a negligible pressure drop or fluid disturbance when compared to the bulky monitoring sensors due to (1) the microchannel and (2) the mechanically flexible base, which matches different pipes diameters and surfaces. The microchannel ensures the laminar flow in the sensing area regardless of the pipe flow type. Also, the bridge design for the microchannel uses the fluid drive force from the pipe to drive the same fluid into the microchannel, without the need for a pumping system or manual withdrawal samples. In addition, the viscosity sensor's fabrication process was developed with low-cost materials and lithography-free procedures to make the sensor inexpensive. The experimental results show that the viscosity of the fluid flowing through the microchannel is inversely proportional to the measured pressure, at constant pipe flow, due to the change in the microfluidic flow rate. A stand-alone system was integrated with the viscosity sensor for real-time monitoring using wireless communication between the viscosity sensor and a smartphone or a similar device, for a plastic pipe up to 50 cm in diameter.

The disclosed embodiments provide a viscosity sensor that is capable of accurately measuring the viscosity of a fluid flowing through a pipe, by estimating a pressure inside a microchannel formed within the pipe. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] Ball, J. M. In-line viscometer 1987.
[2] Carapelli, G. Viscosity dependent flow meter for use infuel dispensing environments 2014.
[3] Wiklund, J.; Stading, M.; Trägårdh, C. Monitoring liquid displacement of model and industrial fluids in pipes by in-line ultrasonic rheometry. J. Food Eng. 2010, 99, 330-337, doi:10.1016/j.jfoodeng.2010.03.011.
[4] Kotzé, R.; Haldenwang, R.; Fester, V.; ROssle, W. In-line rheological characterisation of wastewater sludges using non-invasive ultrasound sensor technology. Water SA 2015, 41, 683-690, doi:10.4314/wsa.v41i5.11.
[5] Han, Z.; Tang, X.; Zheng, B. A PDMS viscometer for microliter Newtonian fluid. J. Micromechanics Microengineering 2007, 17, 1828-1834, doi:10.1088/0960-1317/17/9/011.
[6] Shih, J. L.; Kobayashi, M.; Jen, C. K. Flexible ultrasonic transducers for structural health monitoring of pipes at high temperatures. In Proceedings of the Proceedings—IEEE Ultrasonics Symposium; 2009.
[7] Rodd, L. E.; Scott, T. P.; Boger, D. V.; Cooper-White, J. J.; McKinley, G. H. The inertio-elastic planar entry flow of low-viscosity elastic fluids in micro-fabricated geometries. J. Nonnewton. Fluid Mech. 2005, 129, 1-22, doi:10.1016/j.jnnfm.2005.04.006.
[8] Bamshad, A.; Nikfarjam, A.; Sabour, M. H. Capillary-based micro-optofluidic. Meas. Sci. Technol. 2018.
[9] Kohl, M. J.; Abdel-Khalik, S. I., Jeter, S. M.; Sadowski, D. L. A microfluidic experimental platform with internal pressure measurements. Sensors Actuators, A Phys. 2005, 118, 212-221, doi:10.1016/j.sna.2004.07.014.
[10] Liu, J.; Tai, Y. C.; Ho, C. M. MEMS for pressure distribution studies of gaseous flows in microchannels. Proc. IEEE Micro Electro Mech. Syst. 1995, 209-215, doi:10.1109/memsys.1995.472578.
[11] Elbuken, C.; Glawdel, T.; Chan, D.; Ren, C. L. Detection of microdroplet size and speed using capacitive sensors. Sensors Actuators, A Phys. 2011, 171, 55-62, doi:10.1016/j.sna.2011.07.007.
[12] Viscometer/Rheometer-On-a-Chip, VROC Technology Available online: https://www.rheosense.com/technology (accessed on May 19, 2020).
[13] Puers, R. Capacitive sensors: when and how to use them. Sensors Actuators A. Phys. 1993, 38, 93-105, doi:10.1016/0924-4247(93)80019-D.

What is claimed is:

1. A viscosity sensor for measuring a viscosity of a fluid flowing in a pipe, the viscosity sensor comprising:
a base made of a flexible material;
a bridge made of a rigid material, wherein the bridge is attached to the base to form a microchannel;
a pressure sensor formed within the base; and
a controller configured to receive a signal indicative of a capacitance change ΔC from the pressure sensor, and to calculate the viscosity of the fluid flowing through the microchannel based on the received capacitance change ΔC.

2. The viscosity sensor of claim 1, wherein the pressure sensor includes first and second metallic plates and a dielectric material sandwiched between the first and second metallic plates.

3. The viscosity sensor of claim 2, wherein the dielectric material is air.

4. The viscosity sensor of claim 2, wherein the first metallic plate is formed directly over a first face of the base, and the second metallic plate is formed directly over a second face of the base, and the first face is opposite to the second face.

5. The viscosity sensor of claim 1, wherein the microchannel has a height H between 100 and 500 μm.

6. The viscosity sensor of claim 1, wherein the bridge has two side walls and one top wall, and the height is a distance between the base and the top wall.

7. The viscosity sensor of claim 6, wherein the base includes first to third layers, the first layer has one of two metal plates formed over a first surface, the third layer has another one of the two metal plates formed over a second surface, and the second layer, which is sandwiched between the first and the third layers, has a hole corresponding to the first and second plates.

8. The viscosity sensor of claim 1, wherein the base is made from polydimethylsiloxane (PDMS) and the bridge is formed from poly(methyl-methacrylate) (PMMA).

9. A viscosity sensor system for measuring a viscosity of a fluid flowing in a pipe, the viscosity sensor system comprising:
a viscosity sensor having a base made of a flexible material, a bridge made of a rigid material, wherein the bridge is attached to the base to form a microchannel, and a pressure sensor formed within the base;
a controller configured to receive a signal indicative of a capacitance change ΔC, from the pressure sensor, and to calculate the viscosity of the fluid flowing through the microchannel based on the received capacitance change ΔC; and
a power source configured to supply electrical power to the pressure sensor.

10. The viscosity sensor system of claim 9, wherein the pressure sensor includes first and second metallic plates and a dielectric material sandwiched between the first and second metallic plates.

11. The viscosity sensor system of claim 10, wherein the dielectric material is air.

12. The viscosity sensor system of claim 10, wherein the first metallic plate is formed directly over a first face of the base, and the second metallic plate is formed directly over a second face of the base, and the first face is opposite to the second face.

13. The viscosity sensor system of claim 9, wherein the microchannel has a height H between 100 and 500 μm.

14. The viscosity sensor system of claim 9, wherein the bridge has two side walls and one top wall, and the height is a distance between the base and the top wall.

15. The viscosity sensor system of claim 14, wherein the base includes first to third layers, the first layer has one of two metal plates formed over a first surface, the third layer has another one of the two metal plates formed over a second surface, and the second layer, which is sandwiched between the first and the third layers, has a hole corresponding to the first and second plates.

16. The viscosity sensor system of claim 9, wherein the base is made from polydimethylsiloxane (PDMS) and the bridge is formed from poly(methyl-methacrylate) (PMMA).

17. The viscosity sensor system of claim 9, wherein the controller is formed on the base, and the microcontroller includes a processor, the power source, and a transmitter configured to transmit the signal, in a wireless manner, from the viscosity sensor to a device external to the pipe.

18. The viscosity sensor system of claim 9, wherein the controller is formed outside the pipe, and the controller includes a processor and a wire that is connected to the viscosity sensor to receive the signal.

19. The viscosity sensor system of claim 9, wherein the base is attached to an internal wall of the pipe so that a longitudinal axis of the microchannel is parallel to a longitudinal axis of the pipe.

20. A method for measuring a viscosity of a fluid flowing through a pipe, the method comprising:
attaching a viscosity sensor to an inside of the pipe, the viscosity sensor having a base made of a flexible material that directly attaches to the inside of the pipe, a bridge made of a rigid material, wherein the bridge is attached to the base to form a microchannel, and a pressure sensor formed within the base;
flowing the fluid through the pipe so that part of the fluid flows through the microchannel;
measuring a change in a capacitance associated with the pressure sensor, as the fluid flows within the microchannel; and
determining the viscosity of the fluid flowing through the pipe based on the measured change in capacitance of the pressure sensor, within the microchannel.
